(19) United States
(12) Patent Application Publication
(10) Pub. No.: US 2003/0149887 A1
(43) Pub. Date: Aug. 7, 2003

(54) Application-specific network intrusion detection

(76) Inventor: Satyendra Yadav, Portland, OR (US)

Correspondence Address: FISH & RICHARDSON, PC, 4350 LA JOLLA VILLAGE DRIVE, SUITE 500, SAN DIEGO, CA, 92122, US

(21) Appl. No.: 10/066,070

(22) Filed: Feb. 1, 2002

(51) Int. Cl. G06F 11/30

(52) U.S. Cl. 713/200; 713/152

(57) ABSTRACT

Network intrusion detection accurately identifies and takes into consideration currently running network applications by examining machine instructions embodying those applications. Intrusion detection using application-specific intrusion criteria (e.g., normal communication behavior tracking criteria and/or intrusion signatures) allows application-specific responses to intrusions. Dynamic loading and checking for intrusion signatures may be performed by intrusion detection components that run in the same context as the running application being monitored. A central security authority may provide a repository for, and maintain, up to the minute intrusion signatures for networked machines. Application communications may be tracked to identify abnormal application behavior, and a network security administrator may be notified that a particular application may be making the network vulnerable to intrusion. Immediate response to abnormal application behavior or detection of an intrusion signature is made possible, while non-targeted applications on a targeted computing system may continue their network activity.

### BACKGROUND

This patent application describes systems and techniques relating to network intrusion detection, for example, application-specific network intrusion detection.

A machine network is a collection of nodes coupled together with wired and/or wireless communication links, such as coax cable, fiber optics and radio frequency bands. A machine network may be a single network or a collection of networks (e.g., an internetwork), and may use multiple networking protocols, including internetworking protocols (e.g., Internet Protocol (IP)). These protocols define the manner in which information is prepared for transmission through the network, and typically involve breaking data into segments generically known as packets (e.g., IP packets, ATM (Asynchronous Transfer Mode) cells) for transmission. A node may be any machine capable of communicating with other nodes over the communication links using one or more of the networking protocols.

These networking protocols are typically organized by a network architecture having multiple layers, where each layer provides communication services to the layer above it. A layered network architecture is commonly referred to as a protocol stack or network stack, where each layer of the stack has one or more protocols that provide specific services. The protocols may include shared-line protocols such as in Ethernet networks, connection-oriented switching protocols such as in ATM networks, and/or connectionless packet-switched protocols such as in IP.

As packets travel through a network, they are typically encapsulated within other packets multiple times. Encapsulation occurs as packets are transferred between protocols, such as when a packet moves down through a protocol stack. Encapsulation enables data to travel from a source process on one node to a destination process on another node, through multiple networks using different protocols and addressing schemes, without the two end nodes knowing anything about the intermediate addressing schemes and protocols.

Machine networks may provide powerful communication capabilities, but also may increase the difficulty of maintaining computer system security as a result of making systems and data more accessible. Most networks are susceptible to attacks or improper use, both from inside and from outside the network. Attacks include attempts to gain unauthorized access to data, destroy or bring down a computer system, prevent others from accessing a system and attempts to take control of a system. For example, some network intrusions exploit application anomalies to gain access to a system and infect it with a computer virus, such as Code Red or Nimba.

Frequently, network administrators employ systems to detect network intrusions to improve network security. Traditional network intrusion detection (NID) systems attempt to examine every packet on a network in order to detect intrusions. These NID systems may be implemented as standalone systems (e.g., NFR (Network Flight Recorder), provided by NFR Security, Inc. of Rockville, Md.), or they may be implemented as distributed node-based systems (e.g., BlackICE, provided by Network Ice Corporation of San Mateo Calif.).

### DRAWING DESCRIPTIONS

FIG. 1A is a flowchart illustrating a method of detecting process-specific network intrusions.

FIG. 1B is a flowchart illustrating a method of monitoring and tracking network communications that may be used with the method of FIG. 1A.

FIG. 2A is a block diagram illustrating a networked machine implementing application-specific network intrusion detection.

FIG. 2B is a block diagram illustrating a system implementing application-specific network intrusion detection.

FIG. 3 is a combined state diagram and flowchart illustrating a method of operation and communication for a network intrusion detection system component as may be implemented in the system of FIG. 2B.

FIG. 4 is a combined state diagram and flowchart illustrating a method of operation and communication for a local intrusion signature repository as may be implemented in the system of FIG. 2B.

FIG. 5 is a combined state diagram and flowchart illustrating a method of operation and communication for a security operation center and master intrusion signature repository as may be implemented in the system of FIG. 2B.

FIG. 6 is a block diagram illustrating an example data processing system.

Details of one or more embodiments are set forth in the accompanying drawings and the description below. Other features and advantages may be apparent from the description and drawings, and from the claims.

### DETAILED DESCRIPTION

The systems and techniques described here relate to application-specific network intrusion detection. The description that follows frequently discusses intrusion detection in the context of IP networks, but the systems and techniques described apply equally to other types of machine communication networks.

As used herein, the term “application” means a software program, which is a collection of computing operations embodied by a set of instructions (e.g., one or more binary objects, one or more scripts, and/or one or more interpretable programs). The term “component” means a software program designed to operate with other components and/or applications. The term “process” means an executing software program. The term “execution context” means a set of processing cycles given to a process, such as a task in a multitasking operating system. Both an invoked application and an invoked component are each a process, even if they share a single execution context. For example, both an applet and a Web browser in which the applet runs are each a process. The term “applet” means a component designed specifically to be run from within an application.

The term “intrusion” means an attempt to break into and/or misuse a computing system. The term “intrusion signature” means a communication pattern identified as corresponding to a known type of intrusion, including patterns that may be found in individual packets and patterns that may be gleaned from analyzing multiple packets.

The present inventor recognized the potential advantages of providing network intrusion detection systems and techniques that accurately identify and take into consideration the network applications currently running on a computing system/machine in a networked environment. When applications invoked on a networked machine are accurately identified, network communications for invoked applications may be monitored for application-specific intrusion signatures, and abnormal application behavior may be detected. Moreover, intrusion signatures and behavior criteria may be dynamically loaded from a remote security operation center.

The systems and techniques described here may result in one or more of the following advantages. Improved performance and effectiveness may be realized by checking for application-specific intrusion signatures for only those applications that are running on a computing system. Many known intrusions target specific applications, thus if certain applications are known to be not presently invoked, the corresponding intrusion signatures need not be checked.

Performance penalties incurred by intrusion detection may be limited to specific applications by performing intrusion detection in the same execution context as the running application. Thus, detecting intrusions for applications with many known intrusions (e.g., Microsoft Internet Information Server (IIS) has complex intrusion signature(s)) may not affect the performance of other applications (e.g., File Transfer Protocol (FTP) server) on the same machine. Up to the minute intrusion signature updates may be implemented through dynamically updated signatures from a central security authority (e.g., a company's Information Technology department and/or a security service provider).

In addition, application communications may be tracked to identify abnormal application behavior. This communication tracking may use application-specific tracking criteria and may make use of the same-context execution and dynamic updating features. Intrusion detection using application-specific intrusion criteria (e.g., intrusion signatures, and/or normal communication behavior tracking criteria) may allow proactive and application-specific responses to potential network intrusions.

If an application begins to behave abnormally and/or if a known intrusion signature is detected in the network stream of that application, a network administrator may be immediately notified and/or network traffic for the affected application may be cut. An immediate response to an intrusion targeted at an application on a computing system may be effected while non-targeted applications on the computing system continue their network activity. Additionally, a network security administrator may be notified that a particular application may be making the network vulnerable to intrusion because the application is behaving abnormally, even if no intrusion signature is known for that application.

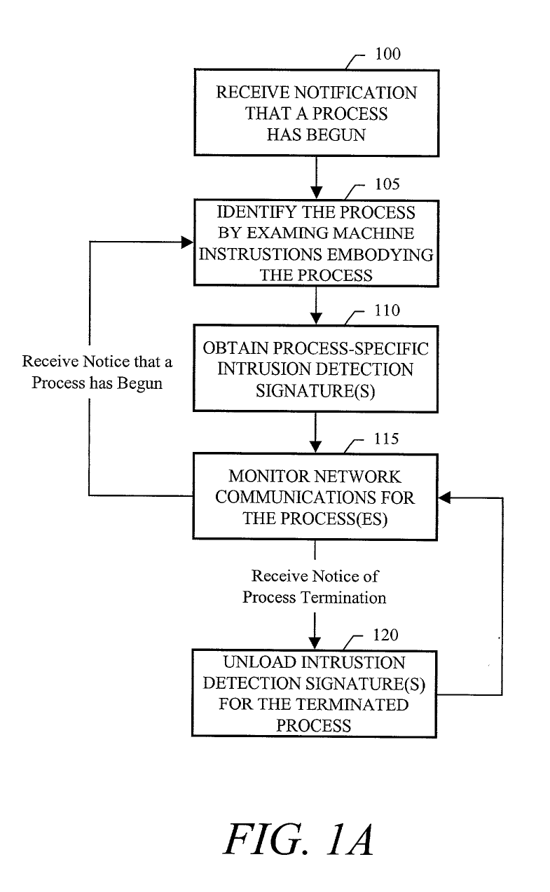

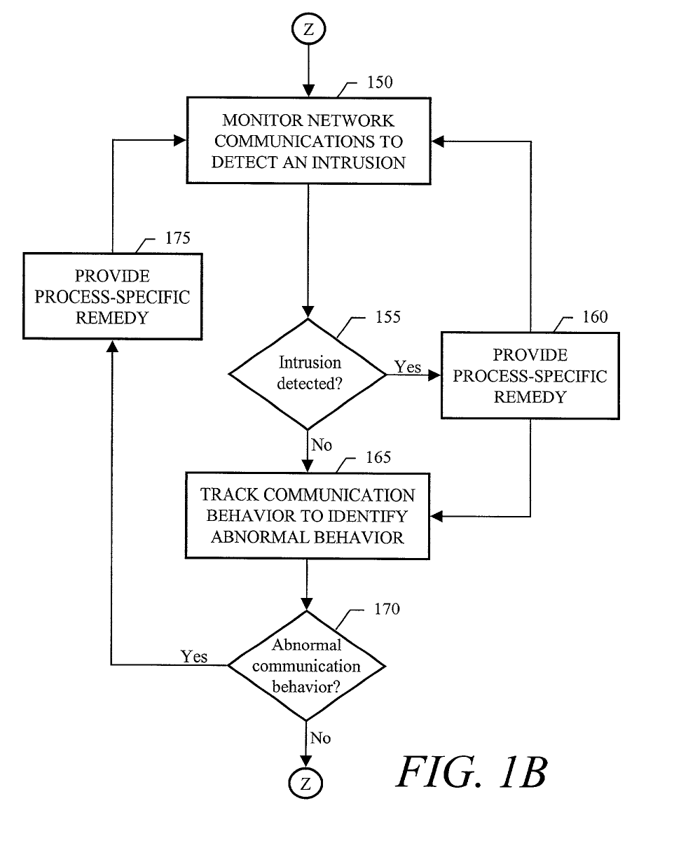

FIG. 1A is a flowchart illustrating a method of detecting process-specific network intrusions. The method begins when a notification that a process has begun is received (100). This notification may be explicit, such as a message being sent to a network intrusion detection system (NIDS), or it may be implicit, such as a component of a NIDS being invoked when the process begins.

Next, the process is identified by examining machine instructions embodying the process (105). For example, the process may be an invoked application, and the examination of the machine instructions may involve applying a hash function to the application's executable to generate a condensed representation (or hash value) of the executable. This hash value may then be compared with predefined hash values for known applications to identify the invoked application.

The hash function may be a message digest algorithm with a mathematical property that effectively guarantees that for any size message, a unique value of a fixed size (e.g., 128 bits) is returned. The hash function may be part of a standardized message digest specification (e.g., Secure Hash Standard (SHA-1), defined in Federal Information Processing Standards Publication 180-1).

Following process identification, one or more process-specific intrusion detection signatures are obtained (110). For example, the process may be an application that has multiple known exploits/bugs that enable intrusion into a computing system through the application's network communications. These known exploits/bugs may be codified in one or more application-specific intrusion detection signatures that are loaded by a NIDS when the application is invoked.

Then, network communications for one or more processes are monitored (115). Generally, network communications are checked only for intrusion signatures that correspond to the identified processes. If a notice is received that another process has begun, the new process is identified and its process-specific signature(s) are obtained. If a notice of process termination is received, the corresponding process-specific signature(s) are unloaded (120).

This dynamic loading and unloading of process-specific intrusion detection signatures may reduce the processing time consumed by intrusion detection, since intrusion signatures for applications that have not been invoked need not be checked. By accurately identifying all processes on a computing system, the NIDS on the computing system may be made more efficient and effective. If an unknown process is started, an alert may be sent to a system administrator and all known intrusion signatures may be loaded temporarily to help protect the computing system.

FIG. 1B is a flowchart illustrating a method of monitoring and tracking network communications that may be used with the method of FIG. 1A. The method includes monitoring network communications to detect an intrusion (150). If an intrusion is detected (155), a process-specific remedy is provided (l60).

For example, network communications for the process that is a target of the detected intrusion may be terminated or monitored more closely. In addition, an alert of the detected intrusion may be sent to a system administrator. This alert may specifically identify the process, the computing system on which it is running and the type of intrusion detected.

The method also includes tracking communication behavior to identify abnormal behavior (165). The communication behavior of a process may be tracked and compared with normal communication behavior for that process. The normal communication behavior for a process may be defined by a user, a network administrator, or may be a provided by a third party software vendor.

For example, normal behavior may be set by one or more configurable thresholds for one or more characteristics of network communications. The configurable thresholds may be set directly by a NIDS component, and/or by a network administrator, after analysis of communication statistics for the process. Thus, network administrators may set the configurable thresholds, such as by including them with intrusion signatures provided by security service providers, and/or the configurable thresholds may be auto-configurable, such as by monitoring communications during a defined time window.

The characteristics of network communications may include destination addresses communicated with, information on connection requests received, and information on connections opened, such information including number, type and frequency of connections requested/opened and direction of opened connections (i.e., which machine initially requested the connection). For example, the number of currently opened connections may be tracked to help detect a denial of service attack. Additionally, many attacks on a computing system begin with a port scan, thus the number of connection requests across all ports also may be a tracked characteristic.

If abnormal communication behavior is detected (170), a process-specific remedy is provided (175). For example, network communications for the process that has abnormal communication behavior may be terminated or monitored more closely. In addition, an alert of the detected intrusion may be sent to a system administrator. This alert may specifically identify the process, the computing system on which it is running and the type of abnormal behavior detected.

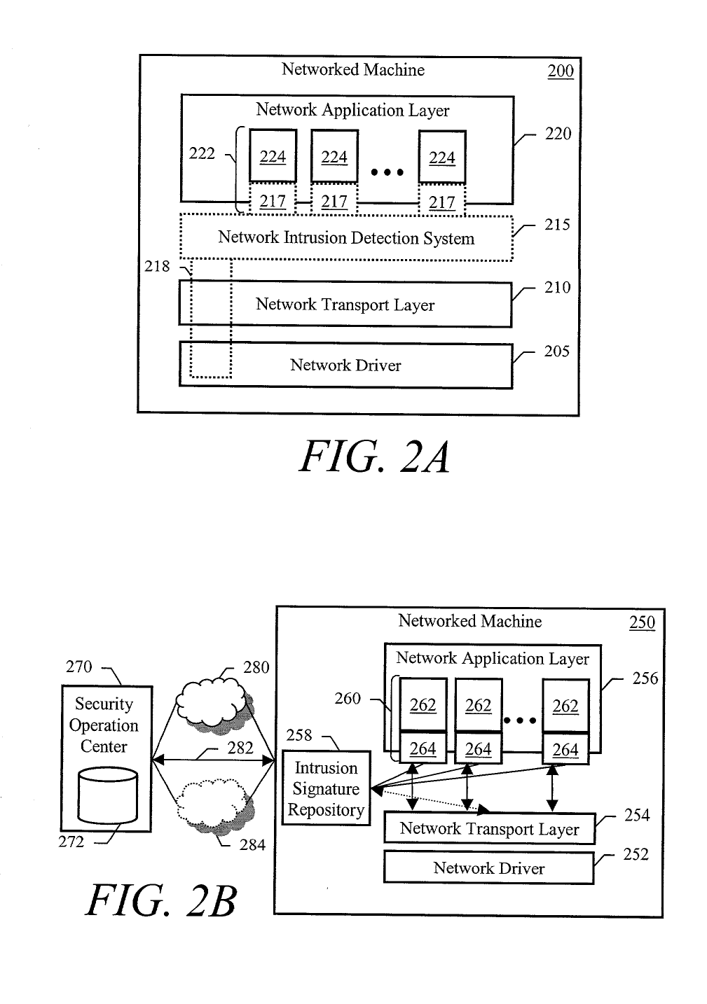

FIG. 2A is a block diagram illustrating a networked machine 200 implementing application-specific network intrusion detection. The networked machine 200 includes a network stack, which is a set of layered software modules implementing a defined protocol stack. The number and composition of layers in the network stack will vary with machine and network architecture, but generally includes a network driver 205, a network transport layer 210 (e.g., TCP/IP (Transmission Control Protocol/Internet Protocol)) and an application layer 220.

A network intrusion detection system (NIDS) 215 is implemented just below and/or just inside the application layer 220 (i.e., as part of a network interface library). Thus, network services requested by applications 224 go to the NIDS 215 first, and the NIDS 215 knows which application requested which network service. For example, in a Windows operating system environment, the NIDS 215 may be implemented as a WinSock Layer Service Provider (LSP) and/or as a TDI (Transport Driver Interface) filter driver. WinSock stands for Windows Socket, which is an Application Programming Interface (API) for developing Windows programs that communicate over a network using TCP/IP.

The NIDS may use components 217 that load and run with each new network application 224 in an execution context 222 for that network application. These components 217 may perform the intrusion signature detection described above, thus the processing time consumed by intrusion detection affects only corresponding network applications. Applications with many known exploits will suffer a corresponding performance penalty, without penalizing other applications running on the machine 200. The components 217 may also perform the tracking of communication behavior described above for each running network application.

In addition, the NIDS 215 may have additional components 218 placed lower in the network stack. For example, system-level intrusion detection may be implemented in one or more TDI filter drivers, and packet-level intrusion detection may be implemented in an NDIS (Network Driver Interface Specification) intermediate driver in a Windows environment.

FIG. 2B is a block diagram illustrating a system implementing application-specific network intrusion detection. The system includes multiple networked machines, such as a networked machine 250. The networked machine 250 includes a network driver 252 and a network transport layer 254. The machine 250 also includes an application layer 256.

Multiple network applications 262 run in the network application layer 256, and each of these applications 262 have a corresponding NIDS component 264 that loads with the application and runs between the application and the network transport layer 254 (e.g., a TCP/IP stack). The NIDS component 264 uses a local intrusion signature repository 258 that stores and/or manages application-specific intrusion signatures.

The application-specific intrusion signatures are represented using a predefined schema. The intrusion signature repository 258 may be a data file (e.g., a flat file in American Standard Code for Information Interchange (ASCII) format), a database and/or a software module that may communicate with a security operation center (SOC) 270. The intrusion signature repository and the components 264 in each machine make up the NIDS for each machine.

Each of these NIDS may communicate with the SOC 270 over a network 280 (i.e., communications 282). These communications 282 may use a protocol for dynamic updates of application-specific intrusion signatures. This protocol provides a communication mechanism for intrusion signature updates between the SOC and the NIDS and may also allow communication of various intrusion alerts to the SOC, as described in greater detail below.

All of the application-specific intrusion signatures for a network domain (e.g., an enterprise network) may be stored in a master intrusion signature repository 272 in the SOC 270, and may be kept up to date by a network security administrator. In addition, the protocol for dynamic updates of application-specific intrusion signatures may use encryption and/or other security techniques to safeguard the communications 282. For example the SOC 270 and the NIDS may communicate over a virtual private network (VPN) 284, with its own encryption and security features, or use Secure Sockets Layer (SSL) to create a secure connection.

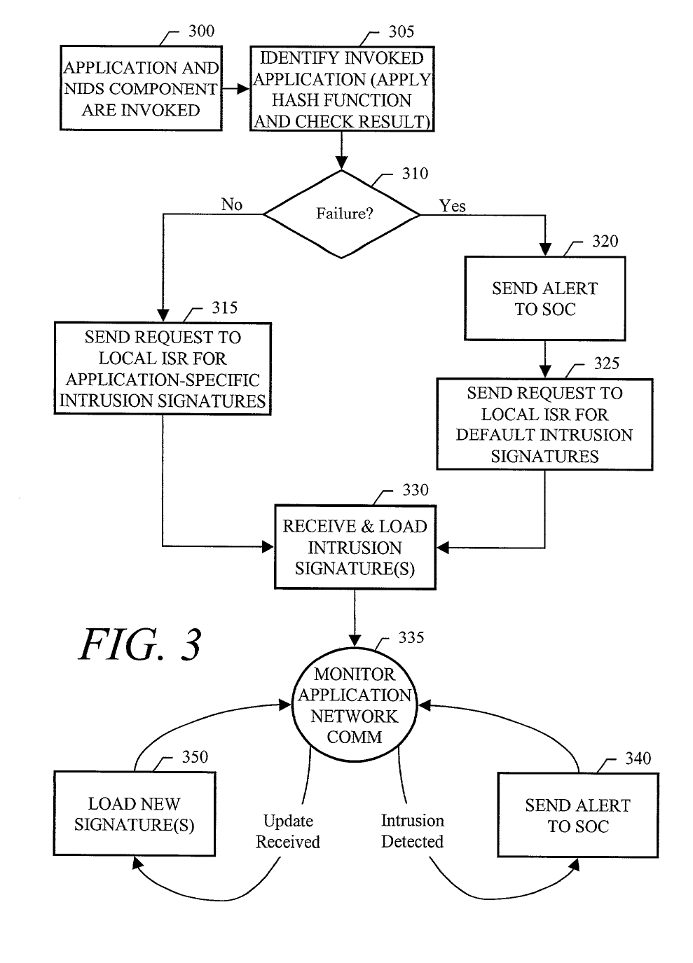

FIG. 3 is a combined state diagram and flowchart illustrating a method of operation and communication for a network intrusion detection system component as may be implemented in the system of FIG. 2B. The method begins when an application and the NIDS component are invoked (300). The NIDS component then identifies the invoked application (305). For example, the NIDS component may determine the full path (directory and file name) of the loading application executable (e.g., “C:/Program Files/Application/application.exe”), examine the machine instructions, such as described above (e.g., a SHA-1 message digest of file contents), to identify the application (e.g., compare message digest result to a pre-computed value), and may also cross check this identification with file properties information, such as name, size and version number.

Then the NIDS component checks if this identification was successful (310). If so, a request is sent to a local intrusion signature repository (LISR) for intrusion signatures specific to the identified application (315). If there is a failure in application identification, an alert is sent to a security operation center (SOC) (320). This alert may include the known application information. Then, a request is sent to the LISR for default intrusion signatures.

The LISR returns intrusion signature(s) for use by the NIDS component, and these signature(s) are received and loaded into an intrusion search engine in the NIDS component (330). Then the NIDS component monitors network communications for the application (335). The NIDS component continuously searches the network stream of the application for the received intrusion signature(s).

If an intrusion is detected, an alert is sent to the SOC (340). Additionally, the NIDS component may cut some or all network traffic to the application, change the state of its monitoring and/or wait for instructions from the SOC in response to the detected intrusion. If an update is received, new intrusion signature(s) are loaded and replace the existing signature(s) used for monitoring (350). The NIDS component continues to monitor network traffic until the application is terminated.

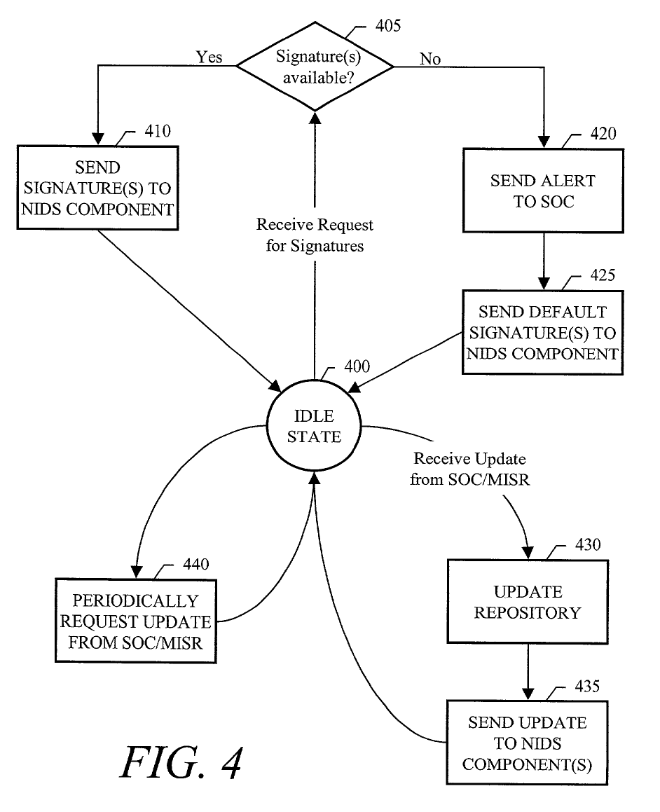

FIG. 4 is a combined state diagram and flowchart illustrating a method of operation and communication for a local intrusion signature repository (LISR) as may be implemented in the system of FIG. 2B. The method begins in an idle state (400). If a request for intrusion signatures is received, a check is made to determine if intrusion signature(s) are available for the identified application (405).

If the application-specific intrusion signature(s) are available, or if default intrusion signature(s) were requested, the signature(s) are sent to the requesting NIDS component (410). If the application-specific intrusion signature(s) are not available, an alert is sent the SOC (420). Then, the default intrusion signature(s) are sent to the requesting NIDS component (425).

If an update from the SOC and/or the master intrusion signature repository (MISR) is received, the LISR updates its data repository with the new information (430). This new information may be new intrusion signature(s) and/or new application identification information for use by later initiated NIDS components. If the new information is new intrusion signature(s), the LISR sends this updated information to NIDS components running with applications corresponding to the update (435).

In addition, the LISR may periodically request updates from the SOC/MISR (440). This periodic communication allows the LISR to keep its data repository up to date, without the SOC having to actively push updates out to all the machines on a network.

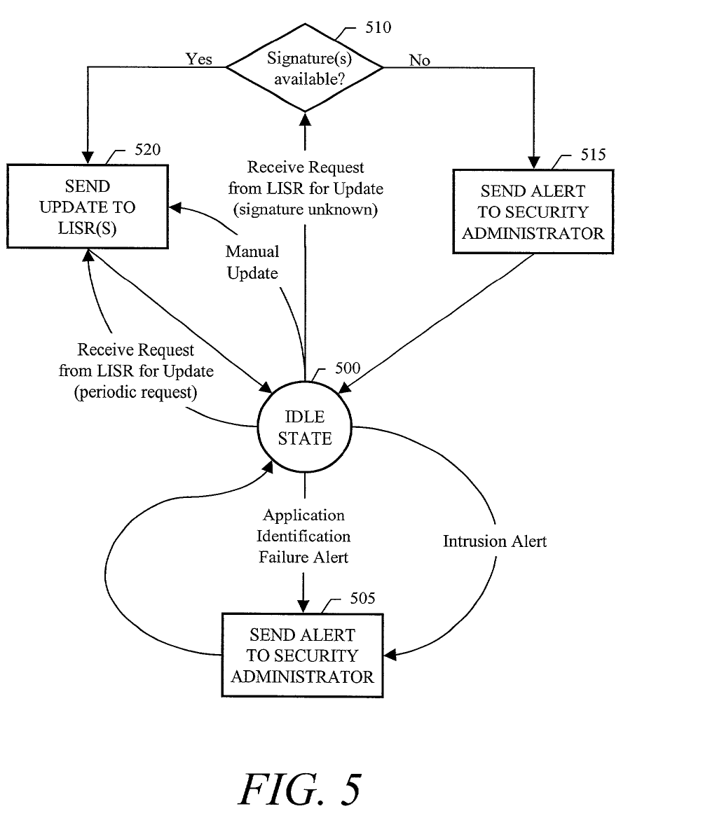

FIG. 5 is a combined state diagram and flowchart illustrating a method of operation and communication for a security operation center and master intrusion signature repository as may be implemented in the system of FIG. 2B. The method begins in an idle state (500). If an application identification failure alert is received from a NIDS component, a security administrator is notified (505). The SOC may thus keep track of any machine on the network that has unauthorized network applications loaded.

If an intrusion alert is received from a NIDS component, a security administrator is notified (505). The SOC may thus keep track of any potential intrusions into the network and may respond accordingly, including sending specific instructions to the NIDS component that identified the intrusion and/or other NIDS components. These instructions may raise levels of monitoring or otherwise heighten network security immediately after an intrusion is detected.

If a request is received from an LISR for an update because an application has been run and the application-specific intrusion signatures are unknown for this application, a check is made to determine if intrusion signature(s) for this application are available (510). If not, an alert is sent to a security administrator (515). If intrusion signature(s) are available for the application, these signature(s) are sent to the requesting LISR (520).

If a periodic update request is received from an LISR, any new intrusion signature(s) and/or any new application identification information may be sent to the requesting LISR (520). If a manual update to intrusion signature(s) and/or application identification information is made, this updated information may be sent to all LISRs (520).

FIGS. 3, 4 and 5 and the accompanying description detail example operations and communications for a NIDS that monitors network communications to identify network intrusions using intrusion signatures. However, as described above, this NIDS may also track communication behavior over time to identify abnormal application behavior. Thus, for example, communication characteristic thresholds that define normal application behavior may also be dynamically loaded and updated as described above in connection with FIGS. 3, 4 and 5. Tracking application-specific communication behavior for machines on a network allows early identification of and proactive response to new types of network intrusions. Thus, a network security administrator may be notified that a particular application may be making the network vulnerable to intrusion, even if no intrusion signature(s) are known for that application.

Various implementations of the systems and techniques described here may be realized in digital electronic circuitry, integrated circuitry, specially designed ASICs (application specific integrated circuits), computer hardware, firmware, software, and/or combinations thereof. These various implementations may include implementation in one or more computer programs that are executable/interpretable on a programmable system including at least one programmable processor, which may be special or general purpose, coupled to receive data and instructions from, and to transmit data and instructions to, a storage system, at least one input device, and at least one output device.

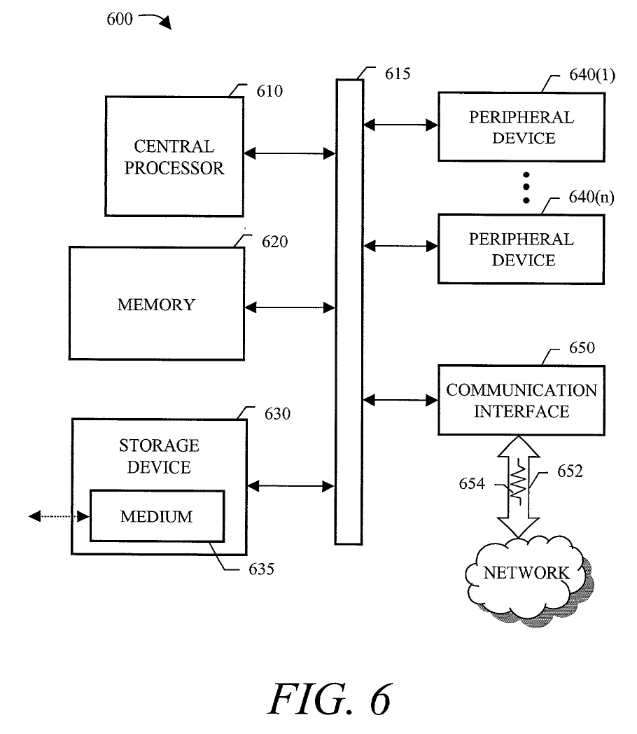

FIG. 6 is a block diagram illustrating an example data processing system 600. The data processing system 600 includes a central processor 610, which executes programs, performs data manipulations and controls tasks in the system 600, thereby enabling the features and function described above. The central processor 610 is coupled with one or more communication busses 615.

The data processing system 600 includes a memory 620, which may be volatile and/or non-volatile memory, and is coupled with the communications bus 615. The system 600 may also include one or more cache memories. These memory devices enable storage of instructions and data close to the central processor 610 for retrieval and execution.

The data processing system 600 may include a storage device 630 for accessing a medium 635, which may be removable. The medium 635 may be read-only or read/write media and may be magnetic-based, optical-based or magneto-optical-based media. The data processing system 600 may also include one or more peripheral devices 640(l)-640(n) (collectively, devices 640), and one or more controllers and/or adapters for providing interface functions. The devices 640 may be additional storage devices and media as described above, other storage interfaces and storage units, input devices and/or output devices.

The system 600 may further include a communication interface 650, which allows software and data to be transferred, in the form of signals 654 over a channel 652, between the system 600 and external devices, networks or information sources. The signals 654 may embody instructions for causing the system 600 to perform operations. The communication interface 650 may be a network interface designed for a particular type of network, protocol and channel medium, or may be designed to serve multiple networks, protocols and/or channel media.

When viewed as a whole, the system 600 is a programmable machine. Example machines represented by the system 600 include a personal computer, a mobile system (e.g., a laptop or a personal digital assistant (PDA)), a workstation, a minicomputer, a server, a mainframe, and a supercomputer. The machine 600 may include various devices such as embedded controllers, Programmable Logic Devices (PLDs), Application Specific Integrated Circuits (ASICs), and the like. Machine instructions (also known as programs, software, software applications or code) may be stored in the machine 600 or delivered to the machine 600 over a communication interface. These instructions, when executed, enable the machine 600 to perform the features and function described above. These instructions represent controllers of the machine 600 and may be implemented in a high-level procedural and/or object-oriented programming language, and/or in assembly/machine language. Such languages may be compiled and/or interpreted languages.

As used herein, the term “machine-readable medium” refers to any medium or device used to provide machine instructions and/or data to the machine 600. Examples include the medium 635, the memory 620, and/or PLDs, FPGAs, ASICs, and the like. The term “machine-readable signal” refers to any signal, such as the signals 654, used to provide machine instructions and/or data to the machine 600.

Other systems, architectures, and modifications and/or reconfigurations of machine 600 of FIG. 6 are also possible. The various implementations described above have been presented by way of example only, and not limitation. For example, the logic flows depicted in FIGS. 1A, 1A, and 3-5 do not require the particular order shown, or that the steps be performed in sequential order. In certain implementations, multitasking and parallel processing may be preferable.

Moreover, although portions of this disclosure discuss application-specific network intrusion detection in the context of TCP/IP and a Windows environment, the system and techniques described are applicable alternative network protocols (e.g., ATM) and alternative operating system environments (e.g., Linux). Thus, other embodiments may be within the scope of the following claims.

What is claimed is:

1. A machine-implemented method comprising:
examining a set of instructions embodying an invoked application to identify the invoked application;
obtaining an application-specific intrusion detection signature; and
monitoring network communications for the invoked application using the application-specific intrusion detection signature to detect an intrusion.

2. The method of claim 1, further comprising tracking one or more characteristics of the network communications to identify application-specific abnormal communication behavior.

3. The method of claim 2, wherein tracking one or more characteristics of the network communications comprises comparing the one or more characteristics with one or more configurable thresholds.

4. The method of claim 3, wherein at least one of the one or more configurable thresholds comprises a threshold set by monitoring communications for the invoked application during a defined time window.

5. The method of claim 2, wherein monitoring network communications comprises monitoring network communications in a network intrusion detection system component invoked with the invoked application.

6. The method of claim 5, wherein the network intrusion detection system component and the invoked application run within a single execution context.

7. The method of claim 6, further comprising:
providing a first application-specific remedy for a detected intrusion; and
providing a second application-specific remedy for identified application-specific abnormal communication behavior.

8. The method of claim 7, wherein providing a first application-specific remedy comprises cutting at least a portion of the network communications for the invoked application, and wherein providing a second application-specific remedy comprises notifying a system administrator of the identified application-specific abnormal communication behavior.

9. The method of claim 6, wherein obtaining the application-specific intrusion detection signature comprises loading the application-specific intrusion detection signature from a local signature repository.

10. The method of claim 6, wherein obtaining the application-specific intrusion detection signature comprises:
requesting the application-specific intrusion detection signature from a local signature repository in communication with a remote signature repository; and
receiving the application-specific intrusion detection signature from the local signature repository.

11. The method of claim 6, wherein the set of instructions reside in a file, and wherein examining the set of instructions comprises:
applying a hash function to data in the file to generate a condensed representation of the data; and
comparing the condensed representation with existing condensed representations for known applications.

12. A machine-readable medium embodying machine instructions for causing one or more machines to perform operations comprising:
examining a set of instructions embodying an invoked application to identify the invoked application;
obtaining an application-specific intrusion detection signature; and
monitoring network communications for the invoked application using the application-specific intrusion detection signature to detect an intrusion.

13. The machine-readable medium of claim 12, wherein the operations further comprise tracking one or more characteristics of the network communications to identify application-specific abnormal communication behavior.

14. The machine-readable medium of claim 13, wherein monitoring network communications comprises monitoring network communications in a network intrusion detection system component invoked with the invoked application.

15. The machine-readable medium of claim 14, wherein the network intrusion detection system component and the invoked application run within a single execution context.

16. The machine-readable medium of claim 15, wherein the operations further comprise:
providing a first application-specific remedy for a detected intrusion; and
providing a second application-specific remedy for identified abnormal communication behavior.

17. The machine-readable medium of claim 16, wherein the first and second application-specific remedies each comprise cutting at least a portion of the network communications for the invoked application.

18. The machine-readable medium of claim 15, wherein obtaining the application-specific intrusion detection signature comprises:
requesting the application-specific intrusion detection signature from a signature repository; and
receiving the application-specific intrusion detection signature from the signature repository.

19. The machine-readable medium of claim 18, wherein the signature repository comprises a local signature repository in communication with a remote signature repository.

20. The machine-readable medium of claim 15, wherein examining the set of instructions comprises:
applying a hash function to the set of instructions to generate a condensed representation; and
comparing the condensed representation with existing condensed representations for known applications.

21. A system comprising:
a network;
a security operation center coupled with the network; and
one or more machines coupled with the network, each machine comprising a communication interface and a memory including an execution area configured to perform operations comprising examining a set of instructions embodying an invoked application to identify the invoked application, obtaining application-specific intrusion criteria, and monitoring network communications for the invoked application using the application-specific intrusion criteria to detect an intrusion.

22. The system of claim 21, wherein the application-specific intrusion criteria comprises a normal communication behavior threshold.

23. The system of claim 21, wherein the application-specific intrusion criteria comprises an intrusion signature.

24. The system of claim 21, wherein monitoring network communications comprises monitoring network communications in a network intrusion detection system component running in an execution context with the invoked application.

25. The system of claim 24, wherein the operations further comprise providing an application-specific remedy for a detected intrusion.

26. The system of claim 25, wherein providing an application-specific remedy comprises cutting at least a portion of the network communications for the invoked application.

27. The system of claim 24, wherein each machine further comprises a local repository, the security operation center includes a master repository, and wherein obtaining the application-specific intrusion criteria comprises:
requesting the application-specific intrusion criteria from the local repository;
requesting the application-specific intrusion criteria from the master repository if the application-specific intrusion criteria is unavailable in the local repository;
receiving the application-specific intrusion criteria from the master repository if requested; and
receiving the application-specific intrusion criteria from the local repository.

28. The system of claim 24, wherein examining the set of instructions comprises:
applying a hash function to the set of instructions to generate a condensed representation; and
comparing the condensed representation with existing condensed representations for known applications.

29. A system comprising:
a security operation center;
one or more machines, each machine including means for identifying a process, obtaining a process-specific intrusion detection signature, and monitoring network communications for the process using the process-specific intrusion detection signature to detect an intrusion; and
communication means coupling the one or more machines with the security operation center.

30. The system of claim 29, wherein each machine further includes means for tracking one or more characteristics of the network communications to identify process-specific abnormal communication behavior.
